(19) United States
(12) Patent Application Publication
(10) Pub. No.: US 2017/0333169 A1
(43) Pub. Date: Nov. 23, 2017

(54) Scaler Tips and Implant Cleaning Inserts

(71) Applicant: Tram Quynh Hoang, San Jose, CA (US)

(72) Inventor: Tram Quynh Hoang, San Jose, CA (US)

(21) Appl. No.: 15/159,724

(22) Filed: May 19, 2016

(51) Int. Cl. A61C 17/00; A61C 8/00; A61C 17/20

(52) U.S. Cl. CPC A61C 17/005; A61C 17/20; A61C 8/0089; A61C 17/036

(57) ABSTRACT

An apparatus for treating peri-implantitis having working angles to allow the user access to difficult to reach areas around the teeth and gums. The apparatus has a first portion and a second portion. The first portion lies on the x-y-plane and the second portion lies on the z-plane. The second portion has an even profile along its length and the length prevents the apparatus from breaking when used at an optimal frequency. The second portion is shaped so as to interchangeably mate with multiple inserts providing the user with different working surfaces.

### BACKGROUND OF THE INVENTION

### 1. Field of the Invention

The present invention relates to dental implants. More particularly, the present invention relates to scaler tips and implant cleaning inserts.

### 2. Background

Peri-implantitis is an inflammatory condition which occurs when the soft and hard tissues become infected with bacteria and foreign bodies like dental cement and bone loss occurs at a dental implant site. The pathogens penetrate the gaps surrounding the dental implants and because these regions are difficult to access, the area becomes ideal for bacterial proliferation.

Periodontists use instruments such as interdental brushes and scaling instruments like scaling tips for local debridement. Certain scaling tips have been shown not to damage the implant surface. This is important because it avoids alteration of the implant surface profile which could lead to increase plaque accumulation and other infection surrounding the peri-implant region. However, these scaling instruments do not provide effective angles needed to properly decontaminate the diseased area. The current scaling instruments have only a two-dimensional structure because the angles lie on the same plane. Effective angles are essential as it allows the periodontist to access complex root anatomy, furcations, tooth implants, and especially posterior tooth implants. Current scaling tips are easily damaged because they break when used at the optimal frequency. This is a problem for periodontists because it is expensive to replace the scaling tips and the damaged scaling tips may injure the patient.

Periodontists use inserts which are attached to the scaling tips. These inserts possess different geometric shapes to aid in the decontamination of the diseased area without further injury to the surface of the implant site. Current inserts are robust and do not have the correct dimensions and design to decontaminate the diseased area.

In light of these problems, there is a need for scaler tips to have working angles to access difficult to reach areas in the mouth. There is a need for an effective scaler tip length so as to resist breaking at optimal frequencies. There is also a need for implant cleaning inserts to have dimensions and designs to effectively decontaminate the diseased area without damaging the implant. Further, there is also a need for a more universal scaler tip with improved working angles that interchangeably accept existing disposable implant cleaning inserts and thereby lower costs.

### SUMMARY

According to an embodiment, there is a scaler tip that has an elongated housing portion, an elongated first portion, and an elongated second portion, a first bend along an axis of the first portion, and a second bend along an axis of the second portion, wherein the first bend and the second bend lie on different planes. The second portion is longer in length than the length of the level/straight portion of a conventional scaler tip, with a shaft having a generally frusto-conical shape that slightly tapers toward the distal tip. The length of the second portion extends evenly along a plane of the second portion. The second portion is shaped to interchangeably mate with different implant cleaning inserts. The housing portion is configured to removably engage to an ultrasonic scaler. The scaler tip can be made from a variety of material such as stainless steel alloy or strong medical grade titanium alloy. The implant cleaning inserts can be made from a rigid but strong plastic material.

According to an embodiment, there is insert for use with a scaler tip comprising an elongated shank having a housing portion at a first distal end, a middle portion, and a tip portion at a second distal end. The first distal end of the housing portion is configured to engage an ultrasonic scaler handpiece. The middle portion has a curved transition to the tip portion and the middle portion has a bend along a length of the middle portion. The tip portion has an even profile along a length of the tip portion. The insert comprises a working portion located at a distal end of the insert and an adjacent non-working portion configured to removably engage with the tip portion of the scaler tip.

According to another embodiment, there is a scaler tip system comprising a scaler tip and an insert. The scaler tip comprises a housing section, a first portion, and a second portion; each of the housing section, the first portion and the second portion further comprises a first end and a second end. The first end of the housing section is configured to removably engage to an ultrasonic scaler and the second end of the housing section transitions to the first end of the first portion. The second end of the first portion transitions to the first end of the second portion and the second portion has an even profile between the first end of the second portion to the second end of the second portion. The scaler tip further comprises a first bend located along the first portion between the first end of the first portion and the second end of the first portion; and a second bend located where the second end of the first portion transitions to the first end of the second portion. The insert is configured to at least partially engage an outer surface of the second portion.

According to an embodiment, there are implant cleaning inserts whose working portion is generally cross-hatched, threaded/helical, smooth, rough, serrated or pyramidal in pattern or generally brush-shaped.

Additional features and benefits of the exemplary embodiment(s) of the present invention will become apparent from the detailed description, figures and claims set forth below.

### BRIEF DESCRIPTION OF THE DRAWINGS

In order to more fully describe embodiments, reference is made to the accompanying drawings. These drawings are not to be considered limitations in the scope of the invention, but are merely illustrative.

FIG. 1 is a perspective view of a left configured scaler tip, according to an embodiment.

FIG. 2 is a perspective view of a right configured scaler tip having an implant cleaning insert, according to an embodiment.

FIG. 3 is a side view of a left configured scaler tip, according to an embodiment.

FIG. 4 is a side view of a right configured scaler tip having an implant cleaning insert, according to an embodiment.

FIG. 5 is a top view of a left configured scaler tip, according to an embodiment.

FIG. 6 is a cross-sectional view of a cross-hatching implant cleaning insert, according to an embodiment.

FIG. 7 is an enlarged view of the working portion of FIG. 6, according to an embodiment.

FIG. 8 is a side view of the working portion of a threaded implant cleaning insert, according to an embodiment.

FIG. 9 is a side view of the working portion of a wire brush implant cleaning insert, according to an embodiment.

FIG. 10 is a side view of the working portion of a smooth implant cleaning insert, according to an embodiment.

FIG. 11 is a side view of the working portion of a rough implant cleaning insert, according to an embodiment.

FIG. 12 is a side view of the working portion of a serrated implant cleaning insert, according to an embodiment.

FIG. 13 is a perspective view of the working portion of a pyramidal implant cleaning insert, according to an embodiment.

FIG. 14 is a perspective view of an insertion tool, according to an embodiment.

FIG. 15 is a side view of an insertion tool, according to an embodiment.

FIG. 16 is another side view of an insertion tool in an open position, according to an embodiment.

### DETAILED DESCRIPTION OF SPECIFIC EMBODIMENTS

The description above and below and the drawings of the present document focus on one or more currently preferred embodiments and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope. Section titles are terse and are for convenience only.

According to embodiments, there is described a scaler tip for treating peri-implantitis. In particular a scaler tip comprises either a left or right configuration. Both left and right embodiments of a scaler tip have three dimensions, meaning, the second hook-shaped section of the scaler tip is on a different plane than the first hook-shaped section. Having the second hook-shaped section of the scaler tip on a different plane provides working angles so the clinician will have better access to different regions of the mouth.

According to embodiments, there is described implant cleaning inserts for treating peri-implantitis. An embodiment of an implant cleaning insert is that the surface of the working portion is cross-hatched. An embodiment of another implant cleaning insert is that the surface of the working portion is threaded. An embodiment of yet another implant cleaning insert is that the surface of the working portion is shaped like a brush. Yet, another embodiment of an implant cleaning insert is that the shape of the working portion is tapered and the surface is smooth, rough or serrated. Yet another embodiment of an implant cleaning insert is that the shape of the working portion is pyramidal. The implant cleaning inserts are made to be interchangeable when used in conjunction with the scaler tip. The scaler tip can be used with or without an implant cleaning insert; however, it is preferable to use it with an implant cleaning insert.

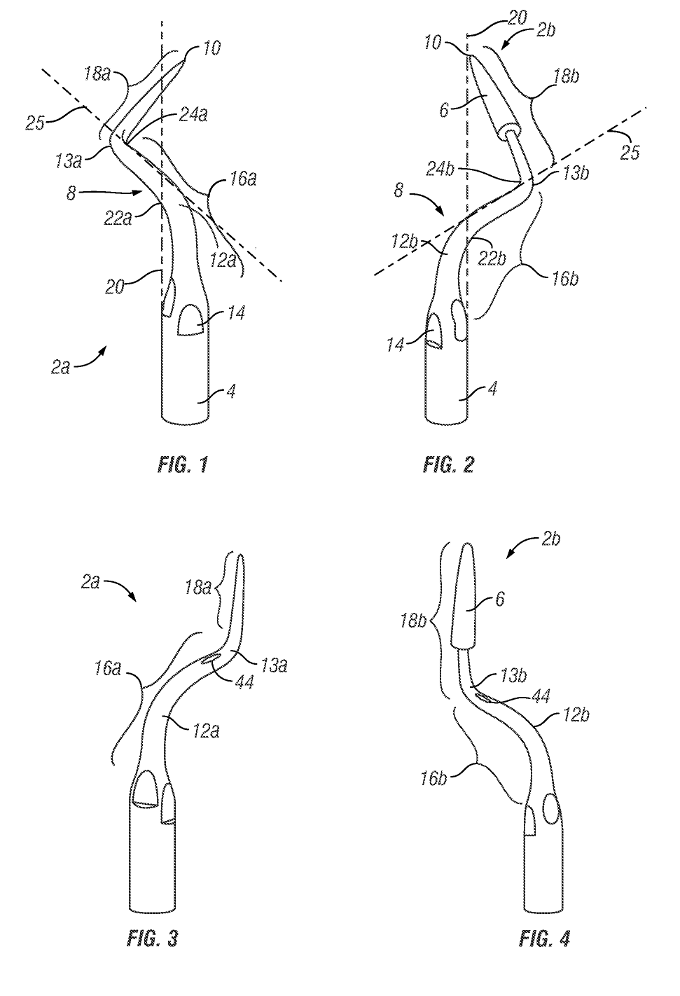

Generally, FIG. 1 and FIG. 2 illustrate scaler tips, according to an embodiment, generally indicated at 2a (FIG. 1) and at 2b (FIG. 2). Each scaler tip 2a and 2b has a housing 4 having female threads therein adapted for threadably receiving the male threads on the output shaft of a handpiece. This handpiece can be a sonic scaler, magnetostrictive scaler or a piezoelectric scaler. The handpiece is connected to a portable control unit, for example, the NSK Varios 350 Optic Complete System (“Varios®”). The Varios® runs in three power modes corresponding to the types of tips (General, Endo and Perio modes). The frequency range of the portable control unit is 28 to 32 kHz, where the power setting at 1 corresponds to the lower frequency and a power setting at 4 corresponds to the higher frequency. When the Varios® is used to power the scaler tip and no anesthesia is used, the clinician can run the power between 1-4 in General mode. When the clinician uses anesthesia, the clinician can run the power between 1-4 in Endo mode. When the clinician uses anesthesia and is in the Perio mode, the power will be at about 3.

Each scaler tip 2a and 2b comprises a shank 8 leading from the housing 4 and ending at the distal tip 10. (For purposes of description, a first end represents an end closest to the housing 4 and a second end represents an end closest to the distal tip 10.) The shank 8 extends in a generally axial direction with respect to the housing 4 and has two hook-shaped sections 12a, 12b and 13a, 13b. The first hook-shaped section 12a, 12b is formed at the first portion 16a, 16b therein between the flats 14 and distal end (second end) of the first portion 16a and 16b. The second hook-shaped section 13a and 13b is formed between the first portion 16a, 16b and second portion 18a, 18b of the shank 8. Each hook-shaped section has a contra angle one 22a, 22b and contra angle two 24a, 24b. Contra angles one 22a, 22b and two 24a, 24b make the scaler tips 2a and 2b readily effective in full-mouth debridement using different scaling techniques. The length of the second portion 18a, 18b is made longer than the length of the level/straight portion of conventional scaler tips to allow for a lower frequency and different amplitudes.

The left configuration (FIG. 1) or right configuration (FIG. 2) is used depending on which side of the mouth is being worked on. Having two contra angles work on different planes allow the clinician to access hard to reach areas such as the back of the mouth which is blocked by the cheeks and lips. In order to reach the back of the mouth, a clinician has to over stretch the patient's lips, causing injury to the corner of the mouth. Certain areas still cannot be reached and cleaned even when the patient's lips over stretched. As such, contra angles one 22a and 22b (first bend) and contra angles two 24a and 24b (second bend) will address these problems. The purpose of contra angles one 22a and 22b and contra angles two 24a and 24b is to allow the clinician to utilize the operative power of the piezoelectric hand-piece anywhere in the mouth because it provides the angles needed to reach inaccessible areas.

The scaler tips 2a and 2b are preferably constructed of different alloys such as medical steel, diamond, plastic alloy, titanium-niobium alloy, or pure titanium. However, the preferred embodiments are not limited to these alloys. The scaler tips 2a and 2b are preferably provided with a fluid passage extending substantially along the length from the housing 4 to an outlet port 44 (not shown, see FIG. 3) located at or near the hook-shaped section 13a and 13b.

Referring now to FIG. 1 illustrating a scaler tip 2a, according to an embodiment, the scaler tip 2a has a hook-shaped section 12a (a first bend) that bends on an x-y-plane with a contra angle one 22a of approximately 130 degrees to an axis 20 set along and edge of the housing 4 and the first portion 16a lies along a first plane (e.g. an x-y-plane). Scaler tip 2a further has a second hook-shaped section 13a (a second bend) that bends on a second plane (e.g. a z-plane) with a contra angle two 24a of approximately 117 degrees to a second axis 25 set along a length of the first portion, after the hook 12a and before the second portion 18a; and the second portion 18a lies along a z-plane. Scaler tip 2a has a left configuration.

In one embodiment, there can be a constant diameter throughout the entire first portion 16a, of the shank 8, the diameter being approximately 3 millimeters. In another embodiment, the shank 8 portion adjacent to the flats 14 can be of a thicker diameter and the diameter can taper slightly towards the distal end of the first portion 16a. According to an embodiment of the present invention, the length of the first portion 16a can be approximately 12 millimeters.

According to an embodiment of the present invention, the diameter of the second portion 18a of the shank 8 can be approximately 1 millimeter and tapers starting from the hook-shaped section 13a to the distal tip 10. The second portion 18a has a tapered surgical length of approximately 12 millimeters and lies/extends evenly along a plane of the second portion 18a of the shank 8, i.e. has an even or straight profile from the hooked-shaped section 13a (first end) to the distal tip 10 (second end). The diameter of the second portion 18a allows the insert 6 to mate with the tapered second portion 18a by a friction fit mechanism. The diameter of the distal tip 10 is approximately 1 millimeter.

Referring now to FIG. 2 illustrating a scaler tip 2b, according to an embodiment, there is a hook-shaped section 12b (a first bend) that bends on an x-y-plane with a contra angle one 22b of approximately 130 degrees to an axis 20 set along and edge of the housing 4 and the first portion 16b lies along a first plane (e.g. an x-y-plane). Scaler tip 2b further has a hook-shaped section 13b (a second bend) that bends on a second plane (e.g. a z-plane) with a contra angle two 24b of approximately 117 degrees to a second axis 25 set along a length of the first portion, after the hook 12b and before the second portion 18b; and the second portion 18b lies along a z-plane. Scaler tip 2b has a right configuration. The right configuration allows the user to access hard to reach areas such as the back of the mouth which is blocked by the cheek and lips. In order to reach the back of the mouth, a clinician has to over stretch the patient's lips, causing injury to the corner of the mouth. Certain areas still cannot be reached and cleaned even when the patient's lips over stretched.

In one embodiment, there can be a constant diameter throughout the entire first portion 16b, of the shank 8, the diameter being approximately 3 millimeters. In another embodiment, the shank 8 portion adjacent to the flats 14 can be of a thicker diameter and the diameter can taper slightly towards the distal end of the first portion 16b. The length of the first portion 16b can be approximately 12 millimeters.

The diameter of the second portion 18b of the shank 8 can be approximately 1 millimeter and tapers starting from the hook-shaped section 13b to the distal tip 10. The second portion 18b has a tapered surgical length of approximately 12 millimeters and lies evenly along a plane of the second portion 18b of the shank 8, i.e. has an even or straight profile from the hooked-shaped section 13a (first end) to the distal tip 10 (second end). The diameter of the second portion 18b allows the insert 6 to mate/engage with the tapered second portion 18b by a friction fit mechanism. When the insert 6 mates with the second portion 18b, preferably, the insert 6 extends between two-thirds to one-half of the length of the second portion 18b allowing the insert 6 to be firmly mated to the second portion 18b and preventing the insert 6 from slipping or detaching during operation. The diameter of the distal tip 10 is approximately 1 millimeter.

FIG. 3 is a side view of a scaler tip 2a, according to an embodiment. In this side view, the hook-shaped section 12a bends along an x-y-plane causing the first portion 16a to lie flat against the same x-y-plane. The hook-shaped section 13a bends along a z-plane causing the second portion 18a to lie flat against the same z-plane. Since the hook-shaped sections 12a and 13a bend along different planes, this creates a 3-D configuration in the scaler tip 2a. The outlet port 44 allows the cooling agent to flow through the scaler tip 2a to keep it from overheating when in use.

FIG. 4 is a side view of a scaler tip 2b, having an implant cleaning insert 6, according to an embodiment. In this side view, the hook-shaped section 12b bends along an x-y-plane causing the first portion 16b to lie flat against the same x-y-plane. The hook-shaped section 13b bends along a z-plane causing the second portion 18b to lie flat against the same z-plane. Since the hook-shaped sections 12b and 13b bend along different planes, this creates a 3-D configuration in the scaler tip 2b. FIG. 4 illustrates the surface of the insert 6 is smooth throughout the piece and is substantially conical in shape.

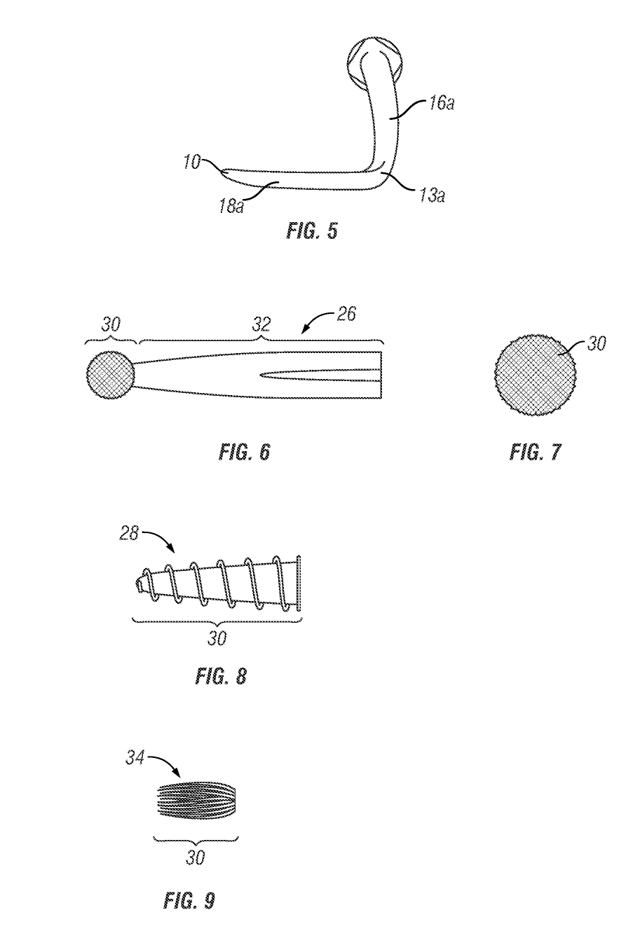

FIG. 5 is a top view of a left configured scaler tip, according to an embodiment illustrating the first portion 16a to be on an entirely different plane than the second portion 18a. The tip 10 is aligned with the second portion 18a. The first portion 16a lies on a different plane than second portion 18a because the hook-shaped section 12a (not shown, see FIG. 1) bends on a different plane than the second hook-shaped section 13a. With the first portion 16a and second portion 18a lying on different planes, the user is able to easily access hard to reach areas of the mouth.

Referring now to FIGS. 6-13, the portion of the insert 6 that contacts the teeth is called the working portion 30 according to embodiments of the present invention. The working portion 30 of each insert 6 described in each preferred embodiment are configured differently. The non-working portion 32 of each insert 6 is configured substantially cylindrical, to mate with the tapered second portion 18a or 18b by a friction fit mechanism. When an insert 6 firmly mates with the second portion 18a or 18b, preferably, the insert 6 extends about one-half of the length of the second portion 18a or 18b thus preventing the insert 6 from slipping or detaching during operation. When using the inserts 6 it is preferable to run the handpiece at medium to high power, which is between 3- 4, with the exception of the wire brush insert 34, which should be run at a lower power, which is between 1-2.

FIG. 6 is a cross-sectional view of a cross-hatching implant cleaning insert, according to an embodiment having a working portion 30 and a non-working portion 32. The cross-hatching implant cleaning insert 26 has a working portion 30 with a surface that is substantially rounded or spherical. The length of the non-working portion 32 is slightly tapered extending toward the direction of the rounded or spherical working portion 30. The second portion 18a, 18b of the scaler tip 2a, 2b is inserted until about two-thirds to one-half of the second portion 18a, 18b is inside the insert 26.

FIG. 7 is an enlarged view of the working portion of FIG. 6, according to an embodiment. The diameter of the substantially rounded or spherical working portion 30 is about 1 millimeter to 2 millimeters, preferably 1.5 millimeters in length. The surface of the working portion 30 has a cross-hatching pattern. The grooves forming the working portion 30 can be shallower or deeper to adjust the size and sharpness of the working portion 30.

FIGS. 8-14 show the working portion 30 of various inserts according to other embodiments of the present invention. FIG. 8 is a side view of the working portion of a threaded implant cleaning insert, according to an embodiment. The threaded insert 28 has a tapered working portion 30 with a surface that is threaded, helical or spiral ridged. The working portion 30 is about 3 to 6 millimeters in length, preferably five millimeters in length and the base of the working portion 30 is about 1.5 to 4.5 millimeters in diameter, preferably 2.5 millimeters in diameter tapering to preferably 1.5 millimeters in diameter. The distance of the pitch can vary and the grooves can be shallower or deeper to adjust the size and sharpness of the working portion 30.

FIG. 9 is a side view of the working portion of a wire brush implant cleaning insert, according to an embodiment. The wire brush insert 34 has a working portion 30 comprising a plurality of wire made of either a titanium or plastic material. The wire brush insert 34 can be used to apply chlorhexidine gel, EDTA gel or tetracycline paste to the patient.

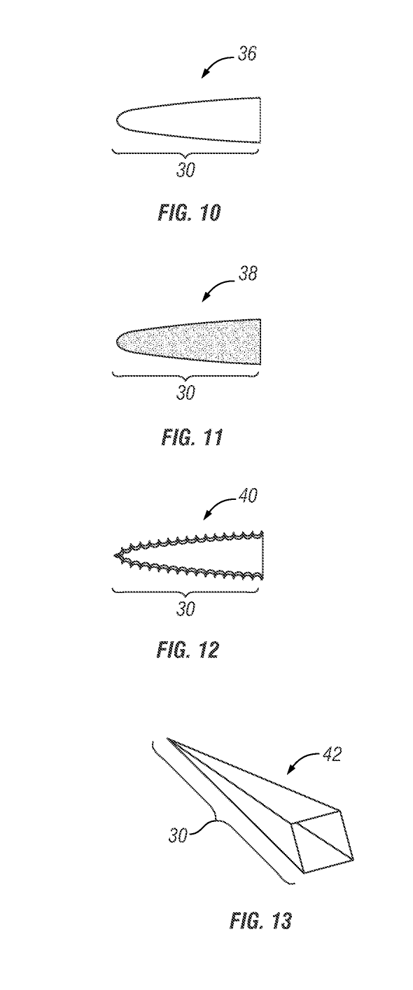

FIG. 10 is a side view of the working portion of a smooth implant cleaning insert, according to an embodiment. The smooth insert 36 has a working portion 30 with a surface that is smooth. The working portion 30 is tapered to form an angle of approximately 1 degree with the longitudinal axis of the second portion 18a or 18b.

FIG. 11 is a side view of the working portion of a rough implant cleaning insert, according to an embodiment. The rough/textured insert 38 has a working portion 30 with a surface that is substantially rasp. The working portion 30 is tapered to form an angle of approximately 1 degree with the longitudinal axis of the second portion 18a or 18b. The grit of the surface can be more fine to more abrasive to adjust the size and abrasiveness of the working portion 30.

FIG. 12 is a side view of the working portion of a serrated implant cleaning insert, according to an embodiment. The serrated insert 40 has a working portion 30 that is substantially pointed. The surface of the working portion 30 comprises a plurality of serrated edges. The length of the non-working portion 32 of the serrated insert is approximately seven millimeters. The grooves can be shallower or deeper to adjust the size and sharpness of the working portion 30.

FIG. 13 is a perspective view of the working portion of a pyramidal implant cleaning insert, according to an embodiment. The pyramidal insert 42 has a working portion 30 with a surface that is substantially pyramidal. The pyramidal insert 42 provides multiple edges with which the user can perform a debridement.

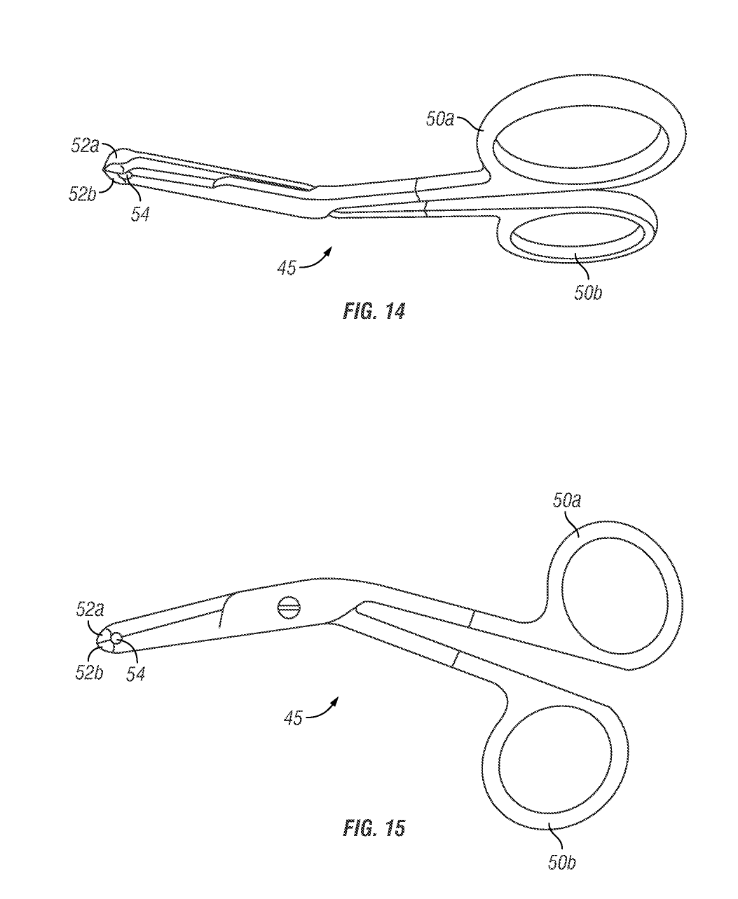

FIG. 14 is a perspective view of an insertion tool 45, according to an embodiment. As illustrated, the insertion tool 45 has handles 50a and 50b, an opening 54 and tips 52a and 52b. The handles 50a and 50b are used to open and close the tips 52a and 52b of the insertion tool 45. Variation in the size and shape of the handles 50a and 50b are possible. When the clinician brings the handles 50a and 50b together, the tips 52a and 52b come substantially flush against each other to form a closed circle with an opening 54, thus allowing the insertion of a scaler tip 2 to fit substantially tight through the opening 54. When the distal end of the tips 52a and 52b are substantially flush against each other, the diameter of the opening 54 is about 1-2 millimeters, preferably 1.5 millimeters. The thickness of the tips 52a and 52b is between 2-4 millimeters, preferably 3 millimeters. The handles 50a and 50b allow the clinician to keep the opening 54 closed, thus maintaining the opening 54 for the clinician to insert the scaler tip 2 through the opening 54. This allows the clinician to remove or attach different style inserts 6 onto the scaler tip 2 with more ease. For example, these inserts can be the threaded insert 28, wire brush insert 34, smooth insert 36, rough insert 38, serrated insert 40, or pyramidal insert 42.

Current insertion tools are designed to work only with one type of insert because the insertion tool is closed on one side and molded to a specific shape. With this insertion tool 45, the clinician can attach different style inserts 6 to the scaler tip 2 using just one insertion tool 45 because the second portion 18 fits through the opening 54 allowing the clinician access to the distal end of the second portion 18.

FIG. 15 is a side view of an insertion tool 45, according to an embodiment. The opening 54 is in a closed position and ready for a scaler tip 2 to be inserted through the opening 54. As shown in this closed position, the distal end of the tips 52a and 52b are substantially flush against each other.

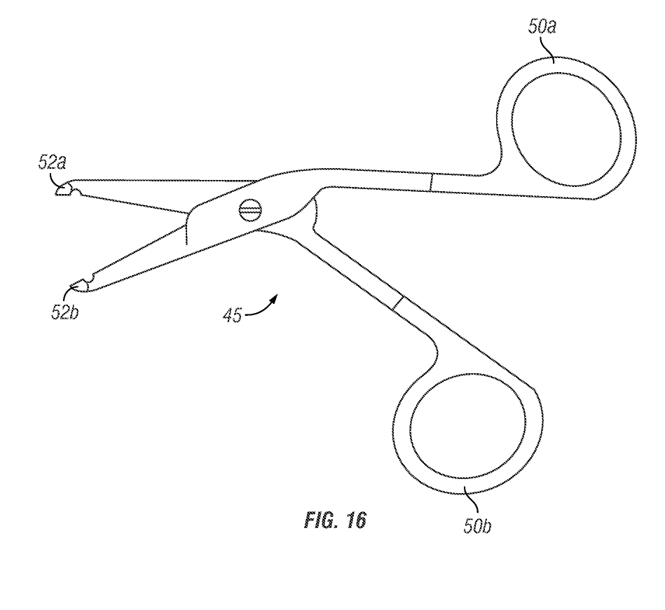

FIG. 16 is another side view of an insertion tool 45 in an open position, according to an embodiment. The opening 54 is in an extended position, which allows the clinician to release the scaler tip 2 from the insertion tool 45.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope for the purpose of the present patent document, is not limited merely to the specific example embodiments or alternatives of the foregoing description.

What is claimed is:

1. A scaler tip for use with an ultrasonic scaler handpiece, the scalar tip comprising:
an elongated shank having a housing section, a first portion, and a second portion;
each of the housing section, the first portion and the second portion further comprises a first end and a second end;
the first end of the housing section is configured to removably engage to an ultrasonic scaler and the second end of the housing section transitions to the first end of the first portion;
the second end of the first portion transitions to the first end of the second portion; and
the second portion having an even profile between the first end of the second portion to the second end of the second portion;
a first bend located along the first portion between the first end of the first portion and the second end of the first portion; and
a second bend located where the second end of the first portion transitions to the first end of the second portion.

2. The scaler tip of claim 1, wherein the first bend and the second bend lie on different planes.

3. The scaler tip of claim 1, wherein the first bend is at an angle of about 130 degrees to an axis set along a length of an edge of the housing portion.

4. The scaler tip of claim 1, wherein the second bend is at an angle of about 117 degrees to an axis set along a length of the first portion between the first bend and the second end of the first portion.

5. The scaler tip of claim 1, wherein the second portion is about 12 millimeters long.

6. The scaler tip of claim 1, further comprising an insert mountable onto the second portion.

7. The scaler tip of claim 6, wherein the insert is made of a plastic material.

8. The scaler tip of claim 6, wherein the insert is made of a metal material.

9. The scaler tip of claim 6, wherein a profile of the insert is shaped substantially from a form selected from the group consisting of a sphere, a helix, a wire brush, a cone and a pyramid.

10. The scaler tip of claim 9, wherein the profile of the insert shaped substantially as a cone comprises serrated grooves.

11. The scaler tip of claim 9, wherein the profile of the insert shaped substantially like a sphere comprises grooves that are X-shaped.

12. An insert for use with a scaler tip comprising an elongated shank having a housing portion at a first distal end, a middle portion, and a tip portion at a second distal end;
the first distal end of the housing portion being configured to engage an ultrasonic scaler handpiece; the middle portion having a curved transition to the tip portion; the middle portion having a bend along a length of the middle portion; the tip portion having an even profile along a length of the tip portion;
the insert comprising:
a working portion located at a distal end of the insert and an adjacent non-working portion configured to removably engage with the tip portion of the scaler tip.

13. The insert of claim 12, wherein the insert is made of a plastic material.

14. The insert of claim 12, wherein the insert is made of a metal material.

15. The insert of claim 12, wherein the working portion is further shaped substantially in a form selected from the group consisting of a sphere, a spiral, a wire brush, a cone and a pyramid.

16. The insert of claim 15, wherein the working portion shaped substantially as a cone comprises a serrated outer surface.

17. The insert of claim 15, wherein the working portion shaped substantially as a sphere comprises grooves that are X shaped.

18. A scaler tip system for use with an ultrasonic scaler handpiece, the scalar tip system comprising:
a scaler tip having a housing section, a first portion, and a second portion; each of the housing section, the first portion and the second portion further comprises a first end and a second end;
the first end of the housing section is configured to removably engage to an ultrasonic scaler and the second end of the housing section transitions to the first end of the first portion; the second end of the first portion transitions to the first end of the second portion; and the second portion having an even profile between the first end of the second portion to the second end of the second portion;
a first bend located along the first portion between the first end of the first portion and the second end of the first portion; a second bend located where the second end of the first portion transitions to the first end of the second portion; and
an insert configured to at least partially engage an outer surface of the second portion.

19. The scaler tip system of claim 18, wherein the second portion is about 12 millimeters long.

20. The scaler tip system of claim 18, wherein the insert is further shaped substantially from a form selected from the group consisting of a sphere, a helix, a wire brush, a cone and a pyramid.
